(19) United States
(12) Patent Application Publication
(10) Pub. No.: US 2011/0090966 A1
(43) Pub. Date: Apr. 21, 2011

(54) VIDEO PREDICTIVE CODING DEVICE AND VIDEO PREDICTIVE DECODING DEVICE

(75) Inventors: Takeshi CHUJOH, Kanagawa (JP); Goki Yasuda, Kanagawa (JP)

(73) Assignee: Kabushiki Kaisha Toshiba, Tokyo (JP)

(21) Appl. No.: 12/980,765

(22) Filed: Dec. 29, 2010

Related U.S. Application Data
(63) Continuation of application No. PCT/JP09/61738, filed on Jun. 26, 2009.

(30) Foreign Application Priority Data
Jun. 30, 2008 (JP) 2008-171326

(51) Int. Cl. H04N 11/02

(52) U.S. Cl. 375/240.16; 375/E07.125

(57) ABSTRACT

According to one embodiment, a video coding device includes: a bi-directional predictor that generates a predicted image of an image to be coded by using a reference image, which includes a decoded image of a bi-directionally predictive coded image, and motion vector information; and a coder that codes a prediction error between the image to be coded and the predicted image. The bi-directional predictor generates the predicted image while switching a plurality of arithmetic methods that use different rounding methods.

### CROSS-REFERENCE TO RELATED APPLICATIONS

This application is a continuation of PCT international application Ser. No. PCT/JP2009/061738 filed on Jun. 26, 2009 which designates the United States and which claims the benefit of priority from Japanese Patent Application No. 2008-171326, filed on Jun. 30, 2008; the entire contents of which are incorporated herein by reference.

### FIELD

Embodiments described herein relate generally to a video predictive coding and a video predictive decoding.

### BACKGROUND

In H.264/AVC, a so-called B slice, for which bi-directional prediction for generating a predicted value using two reference images is enabled, is also allowed to be used as a reference image for prediction of another slice. It is known that high coding efficiency can be achieved by a hierarchical bi-directional prediction structure in which the reference structures from B slices are arranged hierarchically (H. Schwarz, D. Marpe and T. Wiegand, Analysis of hierarchical B pictures and MCTF, IEEE International Conference on Multimedia and Expo (ICME '06), Toronto, Ontario, Canada, July 2006).

When a bi-directionally predicted image is referred to, a rounding error is propagated because rounding in a prediction formula to calculate an average value for bi-directional prediction is fixed. Accordingly, the prediction efficiency is decreased.

In video coding technologies, the problem that the rounding error is propagated is already known in a motion compensation interpolation filter technology and a solution to the problem is proposed (Japanese Patent No. 2998741).

### BRIEF DESCRIPTION OF THE DRAWINGS

FIG. 1 is a block diagram of a video predictive coding device;

FIG. 2 is a block diagram of a predicted image generator;

FIG. 3 is a block diagram of a bi-directional predictor;

FIG. 4 is a diagram illustrating a syntax of a rounding control signal;

FIG. 5 is a block diagram of a video predictive decoding device; and

FIG. 6 is a block diagram of a frame memory.

### DETAILED DESCRIPTION

In general, according to one embodiment, a video coding device includes: a bi-directional predictor that generates a predicted image of an image to be coded by using a reference image, which includes a decoded image of a bi-directionally predictive coded image, and motion vector information; and a coder that codes a prediction error between the image to be coded and the predicted image. The bi-directional predictor generates the predicted image while switching a plurality of arithmetic methods that use different rounding methods.

### First Embodiment

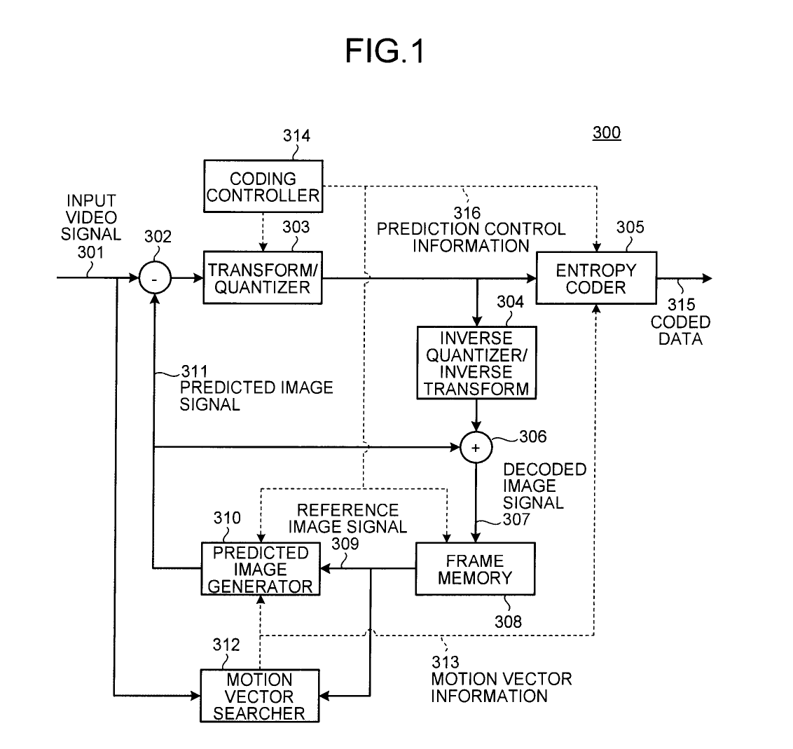

FIG. 1 is a block diagram of a video predictive coding device 300 according to a first embodiment. The video predictive coding device 300 includes a subtractor 302, a transform/quantizer 303, an inverse quantizer/inverse transform 304, an entropy coder 305, an adder 306, a frame memory 308, a predicted image generator 310, a motion vector searcher 312, and a coding controller 314. The video predictive coding device 300 generates coded data 315 from an input video signal 301.

The input video signal 301 is input to the video predictive coding device 300. Each frame of the input video signal 301 is divided into plural blocks to be coded. The predicted image generator 310 generates a predicted image signal 311 of a block to be coded. The subtractor 302 determines the difference between the predicted image signal 311 of a block to be coded and the input video signal 301 of the block to be coded to generate a prediction error signal of the block to be coded.

The transform/quantizer 303 orthogonally transforms the prediction error signal to obtain an orthogonal transform coefficient, and quantizes the orthogonal transform coefficient to obtain quantized orthogonal transform coefficient information. The orthogonal transform may be a discrete cosine transform, for example. The quantized orthogonal transform coefficient information is input to the entropy coder 305 and the inverse quantizer/inverse transform 304.

The inverse quantizer/inverse transform 304 processes the quantized orthogonal transform coefficient information inversely to the processing of the transform/quantizer 303. Specifically, the inverse quantizer/inverse transform 304 inversely quantizes and inversely orthogonally transforms the quantized orthogonal transform coefficient information to reproduce the prediction error signal. The adder 306 adds the locally decoded prediction error signal and the predicted image signal 311 to generate a decoded image signal 307. The decoded image signal 307 is input to the frame memory 308.

The frame memory 308 filters the decoded image signal 307. The frame memory 308 determines whether to store the filtered decoded image signal 307 based on prediction control information 316. The decoded image signal 307 stored in the frame memory 308 is for use as a reference image signal 309 to be input to the predicted image generator 310.

The reference image signal 309 is input to the predicted image generator 310 and the motion vector searcher 312. The motion vector searcher 312 generates motion vector information 313 by using the input video signal 301 and the reference image signal 309. The motion vector information 313 is input to the predicted image generator 310 and the entropy coder 305. The predicted image generator 310 generates the predicted image signal 311 by using the reference image signal 309, the prediction control information 316 and the motion vector information 313.

The coding controller 314 controls the transform/quantizer 303, the predicted image generator 310 and the frame memory 308. The prediction control information 316 generated by the coding controller 314 is input to the predicted image generator 310, the frame memory 308, and the entropy coder 305. The entropy coder 305 entropy-codes coding information including the quantized orthogonal transform coefficient information from the transform/quantizer 303, the prediction control information 316 from the coding controller 314 and the motion vector information 313 from the motion vector searcher 312, and generates the coded data 315 according to a predetermined syntax.

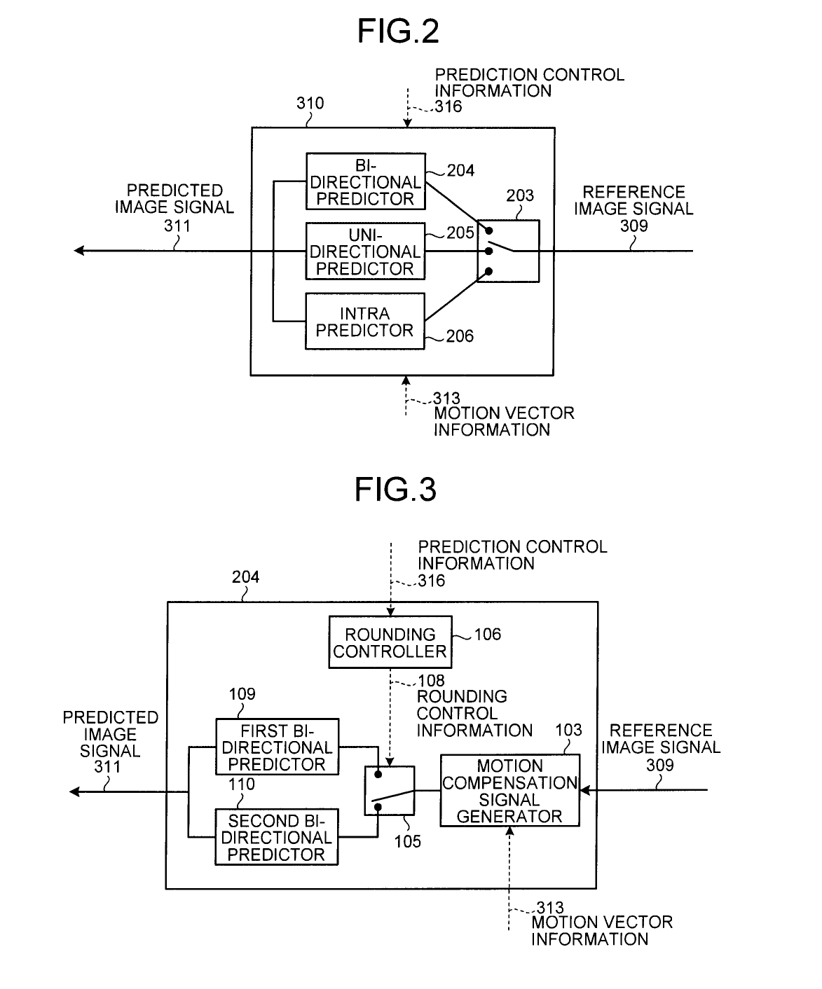

FIG. 2 is a block diagram of the predicted image generator 310. The predicted image generator 310 includes a switch 203, a bi-directional predictor 204, a uni-directional predictor 205, and an intra predictor 206. The predicted image generator 310 generates the predicted image signal 311 from the reference image signal 309 according to the prediction control information 316 and the motion vector information 313.

The switch 203 performs switching between the bi-directional predictor 204, the uni-directional predictor 205, and the intra predictor 206. The reference image signal 309 is input to one of the bi-directional predictor 204, the uni-directional predictor 205 and the intra predictor 206 that is selected by the switch 203.

Each of the bi-directional predictor 204, the uni-directional predictor 205 and the intra predictor 206 generates the predicted image signal 311 from the reference image signal 309. The bi-directional predictor 204 generates the predicted image signal 311 by performing by-directional prediction using the reference image signals 309 of plural reference frames and plural pieces of motion vector information 313. The bi-directional predictor 204 may refer to different regions of the same reference frame according to plural motion vectors.

The uni-directional predictor 205 generates the predicted image signal 311 by using the reference image signal 309 and the motion vector information 313 from a single reference frame. The intra predictor 206 generates the predicted image signal 311 by using an in-frame reference image signal 309.

FIG. 3 is a block diagram of the bi-directional predictor 204. The bi-directional predictor 204 includes a motion compensation signal generator 103, a switch 105, a rounding controller 106, a first bi-directional predictor 109, and a second bi-directional predictor 110. The bi-directional predictor 204 generates the predicted image signal 312 by using the reference image signal 309, the prediction control information 316 and the motion vector information 313.

The motion compensation signal generator 103 generates a motion compensation signal by using the motion vector information 313 and the reference image signal 309. The switch 105 performs switching between the first bi-directional predictor 109 and the second bi-directional predictor 110 according to rounding control information 108. The rounding control information 108 is information that indicates the rounding as an arithmetic method, and designates either one of the first bi-directional predictor 109 and the second bi-directional predictor 110. The motion compensation signal is input to one of the first bi-directional predictor 109 and the second bi-directional predictor 110 to which it is switched. The predicted image signal 311 is generated from the motion compensation signal using the first bi-directional predictor 109 or the second bi-directional predictor 110.

The motion compensation signal generator 103 generates two motion compensation image signals MC_{L0} and MC_{L1} by using the reference image signal 309 from the frame memory 308 and the motion vector information 313 from the motion vector searcher 312.

The rounding controller 106 determines whether or not a decoded image signal that corresponds to the input image signal is to be stored in the frame memory 308 as a reference image signal, wherein the input image signal is a signal that is used with a predicted image signal, which is to be generated, to obtain a prediction difference signal. Specifically, the rounding controller 106 determines whether or not the decoded image signal obtained by orthogonally transforming, quantizing, inversely quantizing, inversely orthogonally transforming and motion compensating the prediction difference signal, which is obtained between the predicted image signal to be generated and the input image signal, is to be stored in the frame memory 308 as a reference image signal. The determination is made based on the prediction control information 316. For example, a Stored B-picture in H.264/AVC is allowed to be used as a reference image. The Stored B-picture is stored in the frame memory 308 as the reference image signal. It is also possible to know that the decoded image signal may be used as a reference image signal based on the prediction control information 316. Thus, the prediction control information 316 is information indicating whether or not an image can be used as the reference image signal.

The rounding controller 106 selects the first bi-directional predictor 109 if the decoded image signal is allowed to be used as a reference image signal for another image to be coded, and selects the second bi-directional predictor 110 if the decoded image signal is not allowed to be used as a reference image signal for another image to be coded.

The first bi-directional predictor 109 and the second bi-directional predictor 110 generate the predicted image signal 311 from the motion compensated image signals MC_{L0} and MC_{L1}. It should be noted that the first bi-directional predictor 109 and the second bi-directional predictor 110 perform integer arithmetic operations.

The first bi-directional predictor 109 and the second bi-directional predictor 110 obtain predicted images by arithmetic operations according to formula (1) and formula (2), respectively. The first bi-directional predictor 109 generates a predicted image signal according to formula (1), and the second bi-directional predictor 110 generates a predicted image signal according to formula (2).

Pred=(MC_{L0}+MC_{L1})>>1 (1)

Pred=(MC_{L0}+MC_{L1}+1)>>1 (2)

Formulae (1) and (2) are both mathematical formulae expressing the arithmetic operations to generate predicted image signals Pred from the motion compensated image signals MC_{L0} and MC_{L1} generated by the motion compensation signal generator 103. The symbol “>>” in formulae (1) and (2) means an arithmetic right shift.

Normally, in a hierarchical bi-directional prediction structure or the like in which a bi-directional prediction being referred to is used, the number of B slices that are referred to is the same as that of B slices that are not referred to. Therefore, when the first bi-directional predictor 109 or the second bi-directional predictor 110 is selected based on the prediction control information 316, the rounding error is balanced out.

In this embodiment, a case in which the first bi-directional predictor 109 uses formula (1) while the second bi-directional predictor 110 uses formula (2) is described. By changing the rounding between a case where the decoded image signal is allowed to be used as a reference image and a case where the decoded image signal is not allowed to be used as a reference image, the propagation of the rounding error can be suppressed. As a result, the prediction efficiency is improved, and thus the coding efficiency is improved.

Since the rounding controller 106 can suppress the propagation of the rounding error by changing the rounding, the configuration may alternatively be such that the first bi-directional predictor 109 uses formula (2) while the second bi-directional predictor 110 uses formula (1), for example.

### Second Embodiment

A second embodiment will be described focusing on the difference thereof from the first embodiment. In the first embodiment, the rounding controller 106 determines the rounding control information 108 indicating the rounding based on the prediction control information 316. In this embodiment, the rounding control information 108 is explicitly coded in a certain coding unit such as in frame units or in slice units.

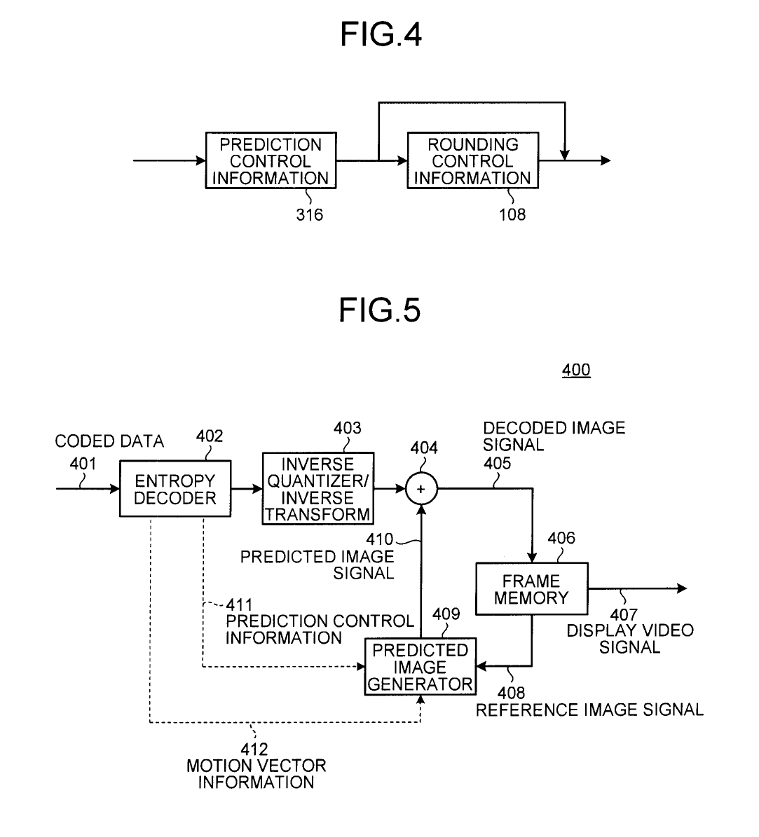

FIG. 4 illustrates an example of a syntax used when the rounding control information 108 is explicitly coded using entropy coding. The prediction control information 316 is information indicating whether or not the decoded image signal in a certain coding unit, such as in frame units or in slice units, is allowed to be used as a reference image signal for another image to be coded for generating a predicted image. If the coding unit is allowed to be used as the reference image signal, the rounding control information is coded and sent, and otherwise, the rounding control information is not coded and is not sent.

### Third Embodiment

A third embodiment will be described focusing on the difference thereof from the first and second embodiments. In this embodiment, the first bi-directional predictor 109 uses formula (3) and the second bi-directional predictor 110 uses formula (4). Formula (3) represents an arithmetic operation of rounding to the nearest even (RN), and formula (4) represents an arithmetic operation of rounding to the nearest odd.

Pred=(((MC_{L0}+MC_{L1})&3)==3)?(MC_{L0}+MC_{L1}+1)>>1:(MC_{L0}+MC_{L1})>>1 (3)

Pred=(((MC_{L0}+MC_{L1})&3)==1)?(MC_{L0}+MC_{L1}+1)>>1:(MC_{L0}+MC_{L1})>>1 (4)

In formula (3), the rounding is changed according to a value of the lower two bits of the sum of MC_{L0} and MC_{L1}. If the value of the lower two bits is 3, an operation of adding 1 and then dividing by 2 is performed, and otherwise, an operation of dividing by 2 is performed without any addition. Formula (3) corresponds to a rounding to the nearest even of an integer arithmetic operation.

In formula (4), the rounding is changed according to a value of the lower two bits of the sum of MC_{L0} and MC_{L1}. If the value of the lower two bits is 1, an operation of adding 1 and then dividing by 2 is performed, and otherwise, an operation of dividing by 2 is performed without any addition. Formula (4) corresponds to a rounding to the nearest odd of an integer arithmetic operation.

The configuration may alternatively be such that the first bi-directional predictor 109 uses formula (4) while the second bi-directional predictor 110 uses formula (3).

### Fourth Embodiment

A fourth embodiment will be described focusing on the difference thereof from the first to third embodiments. In this embodiment, the first bi-directional predictor 109 uses formula (5). In this embodiment, a stochastic rounding in which a pseudo-random number is generated and an offset value R is used is performed.

Pred=(MC_{L0}+MC_{L1}+R)>>1 (5)

In this embodiment, the video predictive coding device 300 and a video predictive decoding device, which will be described later, use a pseudo-random number having the same seed. In this embodiment, a pseudo-random number which is generated in a manner that 0 and 1 are generated in a ratio of 3:1 is used.

It should be noted that as long as 0 and 1 are generated in a ratio of about 3:1, a random number does not have to be used. For example, a method of generating a periodic or regular sequence may be used. Alternatively, other information in the coded data such as a value of the lower two bits of information indicating the number of frames may be used.

### Fifth Embodiment

A fifth embodiment will be described focusing on the difference thereof from the first to the fourth embodiments. In this embodiment, the first bi-directional predictor 109 uses formula (6).

Pred=(((MC_{L1}+MC_{L1})&1)==1)?(MC_{L0}+MC_{L1}+R)>>1:(MC_{L0}+MC_{L1})>>1 (6)

In formula (6), the rounding is changed according to a value of the lower one bit of the sum of MC_{L0} and MC_{L1}. If the value of the lower one bit is 1, an operation of adding an offset value R of a pseudo-random number and then dividing by 2 is performed, and otherwise, an operation of dividing by 2 is performed without any addition. That is, the stochastic rounding is performed only when the sum of MC_{L0} and MC_{L1} is an odd in formula (6).

In this case, the video predictive coding device 300 and the video predictive decoding device, which will be described later, use a pseudo-random number that has the same seed and that is generated in a manner that 0 and 1 are generated in a ratio of 2:1 as the offset value R. As for the pseudo-random number, a random number does not have to be used as long as 0 and 1 are generated in a ratio of about 1:1, and a method of generating a periodic or regular sequence may alternatively be used. Alternatively, other information in the coded data such as a value of the least significant bit of information indicating the number of frames may be used.

### Sixth Embodiment

A sixth embodiment will be described focusing on the difference thereof from the first to the fifth embodiments.

In this embodiment, the first bi-directional predictor 109 uses formula (7) and the second bi-directional predictor 110 uses formula (8).

Pred=(W₀×MC_{L0}+W₁×MC_{L1}+2^{L})>>(L+1)+(O₀+O₁+1)>>1 (7)

Pred=(W₀×MC_{L0}+W₁×MC_{L1}+2^{L}−1)>>(L+1)+(i O₀+O₁)>>1 (8)

In formulae (7) and (8), W₀ and W₁ represent weighting factors and O₀ and O₁ represent offset factors.

Formulae (7) and (8) represent weighted bi-directional prediction. In the first term of formula (7), an operation of adding 2^{L} and then dividing by 2^{L+1} is performed. In formula (7), a fraction equal to or larger than ½ is rounded up and a fraction smaller than ½ is rounded down. That is, the rounding corresponding to rounding 1 to 4 down and 5 to 9 up in the case of a decimal number is performed. In the first term of formula (8), an operation of adding (2^{L-1}) and then dividing by 2^{L+1} is performed. In formula (8), a fraction larger than ½ is rounded up and a fraction equal to or smaller than ½ is rounded down. That is, the rounding corresponding to rounding 1 to 5 down and 6 to 9 up in the case of a decimal number is performed. In the weighted bi-directional prediction according to H.264/AVC, the rounding corresponding to rounding 1 to 4 down and 5 to 9 up is always used. According to this embodiment, since it is switched between formulae (7) and (8), the rounding error is less likely to be propagated.

The rounding to the nearest even and the rounding to the nearest odd as in formulae (3) and (4) or the stochastic rounding as in formulae (5) and (6) may be combined with the prediction formulae of this embodiment.

The configuration may alternatively be such that the first bi-directional predictor 109 uses formula (8) while the second bi-directional predictor 110 uses formula (7).

### Seventh Embodiment

FIG. 5 is a block diagram of a video predictive decoding device 400 associated with the video predictive coding device 300 of the first to sixth embodiments. The video predictive decoding device 400 includes an entropy decoder 402, an inverse quantizer/inverse transform 403, an adder 404, a frame memory 406 and a predicted image generator 409. The video predictive decoding device 400 generates a display video signal 407 from coded data 401.

The entropy decoder 402 entropy-decodes the coded data 401 according to a predetermined syntax. The entropy decoder 402 obtains quantized orthogonal transform coefficient information, prediction control information 411 and motion vector information 412. The decoded quantized orthogonal transform coefficient information is input to the inverse quantizer/inverse transform 403. The decoded prediction control information 411 and the decoded motion vector information 412 are input to the predicted image generator 409. If an image to be decoded is allowed to be used as a reference image for another image to be decoded, the coded data 401 includes rounding control information. In such case, the entropy decoder 402 also extracts the rounding control information by decoding the coded data 401.

The inverse quantizer/inverse transform 403 performs inverse quantization and inverse orthogonal transform to reproduce a prediction error signal. The adder 404 adds the prediction error signal and a predicted image signal 410 to generate a decoded image signal 405.

The decoded image signal 405 is input to the frame memory 406. The frame memory 406 filters the decoded image signal 405 and outputs the resulting signal as the display video signal 407. The frame memory 406 determines whether to store the filtered decoded image signal 405 based on the prediction control information 411. The stored decoded image signal 405 is input to the predicted image generator 409 as a reference image signal 408.

The predicted image generator 409 generates the predicted image signal 410 by using the reference image signal 408, the prediction control information 411 and the motion vector information 412. The configuration of the predicted image generator 409 is the same as that of the predicted image generator 310 of the video predictive coding device 300 described with reference to FIGS. 2 and 3. Specifically, the predicted image generator 409 obtains a predicted image by using the operation of either formula (1) or formula (2) in the same manner as the predicted image generator 310. If the rounding control information is obtained from the coded data 401, the predicted image generator 409 further uses the rounding control information to generate the predicted image signal 410.

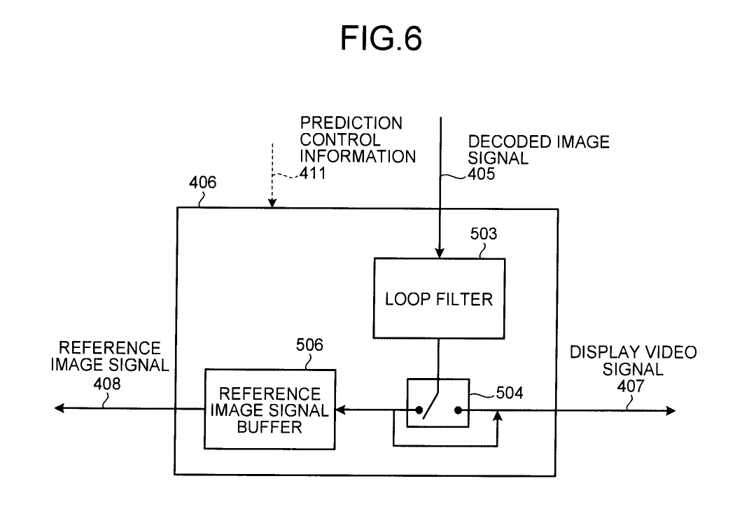

FIG. 6 is a block diagram of the frame memory 406. The configuration of the frame memory 308 shown in FIG. 1 is the same as that of the frame memory 406 shown in FIG. 6. The frame memory 406 includes a loop filter 503, a switch 504 and a reference image buffer 506. The frame memory 406 uses the prediction control information 411 and the decoded image signal 405 to generate the reference image signal 408 and the display video signal 407. The loop filter 503 applies a deblocking filter or an image restoration filter to the decoded image signal 405.

The switch 504 performs switching between storing and not storing the decoded image signal, to which the loop filter 503 has been applied, in the reference image buffer 506 based on the prediction control information 411. If the decoded image signal is allowed to be used as the reference image signal, the decoded image signal is input to the reference image buffer 506. If the decoded image signal is not allowed to be used as the reference image signal, the decoded image signal is not input to the reference image buffer 506.

In the case where the frame memory 406 is arranged on the side of the video predictive decoding device, the decoded image signal, to which the loop filter 503 has been applied, is output as the display video signal 407 both when it is input to the reference image buffer 506 and when it is not input to the reference image buffer 506.

### Eighth Embodiment

An eighth embodiment will be described focusing on the difference thereof from the first to the seventh embodiments. In this embodiment, the rounding controller 106 performs switching between the first bi-directional predictor 109 and the second bi-directional predictor 110 when a decoded image signal corresponding to an input image signal is used as a reference image signal. In this embodiment, the rounding controller 106 selects the second bi-directional predictor 110 if a decoded image signal corresponding to an input image signal is not used as a reference image signal. Thus, when a decoded image signal corresponding to an input image signal is used as a reference image signal, the rounding controller 106 switches plural rounding methods while performing bi-directional prediction. The rounding may be switched in a round-robin fashion or randomly, for example.

The video predictive coding device explicitly entropy-codes the rounding control information indicating the selected rounding. The video predictive decoding device switches the rounding according to the rounding control information extracted from the coded data.

Incidentally, the rounding control information may be coded implicitly. The rounding may be switched based on other information in the coded data such as a value of the least significant bit of information indicating the number of frames.

The video predictive coding device and the video predictive decoding device can also be implemented by using a general-purpose computer as basic hardware. Specifically, the video predictive coding device and the video predictive decoding device can be implemented by making a processor installed in the computer execute a program. In such case, the video predictive coding device or the video predictive decoding device may be implemented by installing the program in the computer in advance, or by storing the program in a storage medium such as a CD-ROM or distributing the program via a network and installing the program in the computer as necessary. Alternatively, the video predictive coding device and the video predictive decoding device can be implemented by appropriately utilizing storage media such as a memory, a hard disk or an optical disc, provided in or externally to the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A video coding device, comprising:
a motion compensation image signal generator that performs motion compensation using at least one reference image and plural pieces of motion vector information to generate motion compensation image signals for a block to be coded, for which bi-directional prediction is applied, the block being included in blocks that are within a unit of coding being bi-directionally predicted;
a bi-directional predictor that generates a predicted image signal for the block to be coded using the motion compensation image signals; and
a coder that codes a prediction error between an input image signal and the predicted image signal of the block to be coded, wherein
the bi-directional predictor selects a rounding method for each unit of coding if a decoded image signal for the unit of coding is allowed to be used as a reference image for another unit of coding.

2. The video coding device according to claim 1, wherein
the coder codes control information indicating the rounding method.

3. The video coding device according to claim 2, wherein
(A) if a decoded image signal for the unit of coding is allowed to be used as a reference image for another unit of coding, the coder codes the control information, whereas
(B) if a decoded image signal for the unit of coding is not allowed to be used as a reference image for another unit of coding, the coder does not code the control information.

4. The video coding device according to claim 3, wherein
the bi-directional predictor performs switching between
(1) a first arithmetic method of dividing a sum of two signals by 2, and
(2) a second arithmetic method of dividing a result of adding 1 to a sum of two signals by 2.

5-6. (canceled)

7. A video decoding device, comprising:
a decoder that extracts, from input coded data, plural pieces of motion vector information and prediction error information of a block to be decoded, for which bi-directional prediction has been applied, the block being included in blocks that are within a unit of coding that has been bi-directionally predicted;
a motion compensation image signal generator that generates motion compensation image signals for the block to be decoded using at least one reference image and the plural pieces of motion vector information;
a bi-directional predictor that generates a predicted image signal of the block to be decoded using the motion compensation image signals; and
a reproducer that adds the predicted image signal and the prediction error information to obtain a decoded image signal of the block to be decoded, wherein
the bi-directional predictor selects a rounding method for each unit of coding if a decoded image signal for the unit of coding is allowed to be used as a reference image for another unit of coding.

8. The video decoding device according to claim 7, wherein
the decoder extracts control information indicating the rounding method from the coded data, and
the bi-directional predictor switches the rounding methods according to the control information.

9. The video decoding device according to claim 8, wherein
the decoder extracts the control information if the decoded image signal for the unit of coding is allowed to be used as a reference image for another unit of coding, and
the bi-directional predictor switches the rounding methods according to the control information.

10. The video decoding device according to claim 9, wherein
the bi-directional predictor performs switching between
(1) a first arithmetic method of dividing a sum of two signals by 2, and
(2) a second arithmetic method of dividing a result of adding 1 to a sum of two signals by 2.

11-12. (canceled)
